(19) United States
(12) Patent Application Publication
(10) Pub. No.: US 2023/0258405 A1
(43) Pub. Date: Aug. 17, 2023

(54) Thermal Processing Apparatus

(71) Applicant: Nano One Materials Corp., Burnaby (CA)

(72) Inventor: Russell H. Barton, Burnaby (CA)

(21) Appl. No.: 18/108,363

(22) Filed: Feb. 10, 2023

Related U.S. Application Data
(60) Provisional application No. 63/311,103, filed on Feb. 17, 2022.

(51) Int. Cl. F27B 7/10; F27B 7/22; H01M 4/04

(52) U.S. Cl. CPC F27B 7/10; F27B 7/2206; H01M 4/0471; F27B 2007/2246; H01M 2004/028

(57) ABSTRACT

Provided is an improved thermal processing apparatus. The thermal processing apparatus comprises a shell and an insulator on the interior of the shell. A liner is on the interior of the insulator wherein the liner forms an inner cavity. A heater is in the inner cavity.

### CROSS-REFERENCE TO RELATED APPLICATIONS

The present application claims priority to pending U.S. Provisional Application No. 63/311,103 filed Feb. 17, 2022 which is incorporated herein by reference.

### FIELD OF THE INVENTION

The present invention is related to an improved thermal processing apparatus. More specifically, the present invention is related to a rotary kiln which is particularly suitable for sintering precursors to cathodes to form lithium-ion cathodes and particularly lithium-ion cathodes comprising at least one of Ni, Mn or Fe and optionally Co or Al for use in lithium-ion batteries.

### BACKGROUND

The wide-spread, and growing, acceptance of battery technology into virtually all sectors requiring energy storage has significantly increased the demand for lithium-ion cathodes for use in lithium-ion batteries. Though not limited thereto, the most widely used lithium-ion battery cathodes are those based on nickel and manganese such as those of general formula LiMO₂; wherein M is a primarily a mixture of Ni and Mn and optionally Co, Al or dopants; LiM′O₄, where M′ is primarily a mixture of Ni and Mn and optionally Co, Al or dopants; and LiM″PO₄, wherein M″ is primarily Fe with optional Mn or dopants.

All of the lithium-ion battery cathodes are formed by sintering a precursor at a high temperature. The temperature varies depending on the material but typical temperatures range up to about 1000° C. There are typically two broad methods of sintering with one being a batch process and the other being a continuous process.

A batch process typically involves the use of a container, typically referred to as a sagger, wherein the precursor is placed. The sagger is exposed to temperature either at a fixed location or with the incorporation of a mechanism that moves the sagger through at least one heat zone. In a batch process a volume of precursor is essentially contained and therefore the entirety of a batch is treated consistently. At manufacturing scale the saggers typically move sequentially through some form of a furnace and therefore some of the advantages of a continuous flow operation are achieved but the process is still a batch process since individual batches are treated simultaneously and the material is relatively stationary within the sagger.

A continuous process is characterized by a flowing powder wherein the precursor enters at least one heated zone and as the powder particles are sintered the sintered particles are removed from the stream as a flowing powder as opposed to a fixed batch within a container. A continuous process is preferred for large scale operation.

As would be realized to those of skill in the art, controlling the residence time of the powder in the heated zone is critical to the manufacture of high-quality lithium-ion cathode material. Controlling the residence time requires some mechanical structure which is necessarily within a furnace or other heated environment. The material of construction and design are critical since the mechanical structure must be suitable for use at very high temperatures, often for very long times and any material of construction should not be detrimental to the electrical properties of the lithium-ion cathode material.

Provided herein is an improved thermal processing apparatus which allows for continuous flow operation and wherein significant portions of the mechanical functionality can be physically separated from the hottest portion of the heating apparatus.

### SUMMARY OF THE INVENTION

The present invention is related to an improved thermal processing apparatus.

A particular advantage of the instant invention is the ability to sinter precursors of lithium-ion cathodes in a rolling hearth wherein the exterior of the rolling hearth is at near ambient temperature thereby significantly minimizing the necessity of mechanical structure associated with a rolling hearth from being inside the heated zone.

These and other advantages, as will be realized, are provided in a thermal processing apparatus. The thermal processing apparatus comprises a shell and an insulator on the interior of the shell. A liner is on the interior of the insulator wherein the liner forms an inner cavity. A heater is in the inner cavity.

Yet another embodiment is provided in a method for forming a cathode material. The method comprises:
providing a thermal processing apparatus comprising:
a shell;
an insulator on the interior of the shell;
a liner on the interior of the insulator wherein the liner forms an inner cavity; and
a heater in said inner cavity;
feeding a precursor to a lithium-ion cathode material in the inner cavity;
rotating the thermal processing apparatus; and
heating the precursor to form the lithium-ion cathode material; and
removing the lithium-ion cathode material from the thermal processing apparatus.

### BRIEF DESCRIPTION OF DRAWINGS

FIG. 1 is a partially cut-away perspective view of an embodiment of the invention.

FIG. 2 is a cross-sectional view of an embodiment of the invention.

FIG. 3 is a cross-sectional view of an embodiment of eth invention.

FIG. 4 is a perspective isolated view of a shell of the invention.

### DESCRIPTION

The invention is related to an improved thermal processing apparatus. More specifically, the present invention is related to a thermal processing apparatus which is a rotary kiln and which is particularly suitable for use in the continuous sintering of precursors for lithium-ion cathode materials to form lithium-ion cathode materials for use in lithium-ion batteries.

The invention will be described with reference to the figures which are an integral, but non-limiting, part of the specification provided for clarity of the invention. Throughout the various figures similar elements will be numbered according.

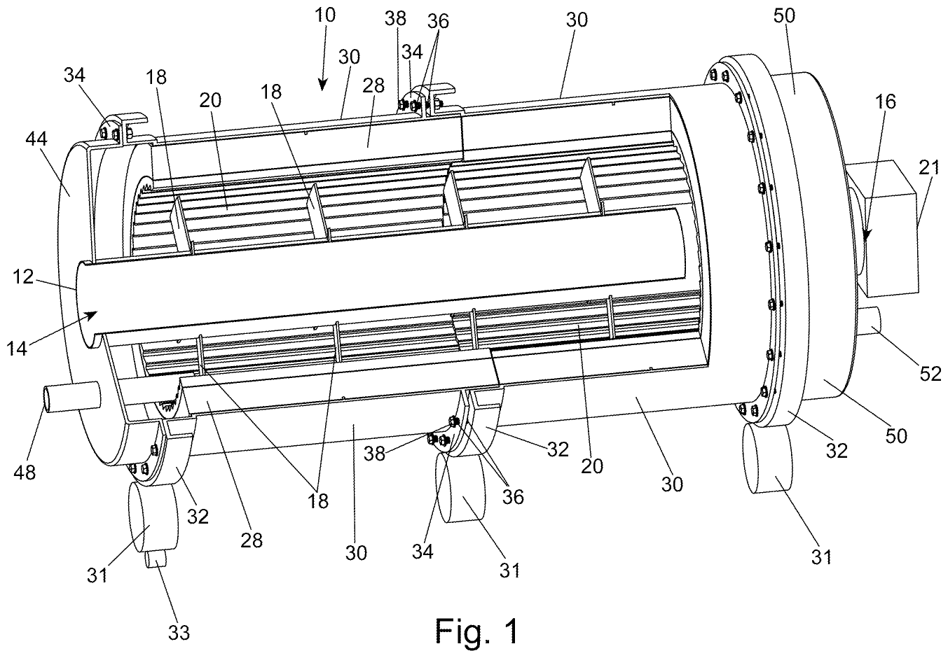

An embodiment of the invention will be described with reference to FIG. 1 wherein a thermal processing apparatus, 10, is illustrated schematically in perspective partial cut-away view. The thermal processing apparatus is generally tubular wherein the sintering occurs in the interior of the thermal processing apparatus. A heater, and preferably a combustion tube, 12, extends through the interior of the thermal processing apparatus wherein a medium passes through the combustion tube to heat the interior of the thermal processing apparatus. The medium passing through the combustion tube can be a pre-heated medium, preferably a gas, or the medium can comprise components of a combustion mixture which combust in the combustion tube to generate sufficient heat to sinter the precursor in the thermal processing apparatus such as up to about 1000° C. The combustion tube comprises an entrance port, 14, wherein the medium is introduced into the combustion tube, and an exhaust port, 16, wherein exhaust gases exit the combustion tube preferably to a heat exchanger, 21. The combustion tube is preferably centrally located within the thermal processing apparatus. More preferably the rotation axis of the combustion tube and the rotation axis of the thermal processing apparatus are parallel and most preferably the rotation axis of the combustion tube and the rotation axis of the thermal processing apparatus are co-linear.

In an embodiment, the outside diameter of the combustion tube is at least 35% to no more than 65% of the inside diameter of the inner cavity. If the combustion tube is too large the tumbling powder may come into contact with the combustion tube which is undesirable. If the combustion tube is too small the amount of surface area is insufficient to generate sufficient radiant heat to heat the entirety of the inside of the inner cavity. An outside diameter of the combustion tube which is at least 40% to no more than 60% of the inside diameter of the inner cavity is more preferred with an outside diameter of the combustion tube which is at least 45% to no more than 55% of the inside diameter of the inner cavity being even more preferred. A combustion tube with an outside diameter about half the inside diameter of the inner cavity is most preferred wherein the inside diameter of the inner cavity is the closest distance between the liner measured perpendicular to the rotation axis of the combustion tube.

A combustion tube made of a refractory metal is particularly suitable for demonstration of the invention. In an embodiment a fuel gas flame is directed through the combustion tube, heating it to incandescence, which heats the interior of the thermal processing apparatus by radiant heat including the liner, 20, and anything contacting the liner surface. The combustion exhaust is preferably directed through a counterflow heat exchanger, 21, to preheat the combustion air thereby reducing fuel gas consumption. The combustion zone can be at one end, or more centrally located, to control the zone of maximum radiant heat.

The combustion tube is not in contact with the powder, so abrasion of the tube, and contamination of the precursor with metal dust is mitigated.

A central electric element can used as a heater, however a combustion tube is preferable due to heating efficiency.

With further reference to FIG. 1, struts, 18, extending between the combustion tube and interior face of the liner, 20, of the thermal processing apparatus maintain the combustion tube in a preferably fixed position relative to the inner cavity of the thermal processing apparatus. It is preferred that the struts are not physically attached to the liner thereby allowing the struts to slide along the axis of rotation in concert with thermal expansion and contraction.

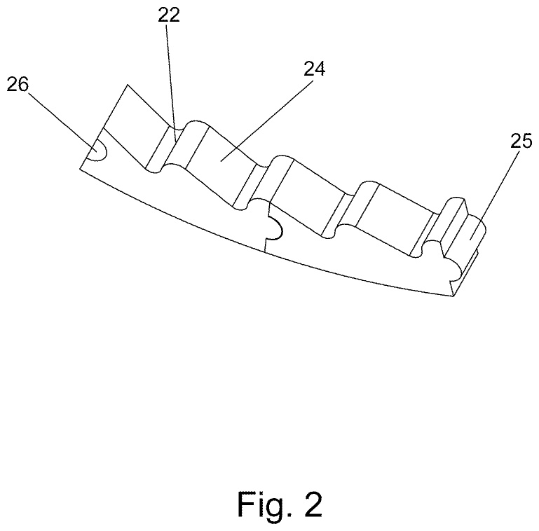

The interior face of the liner, 20, of the thermal processing apparatus has a surface contour to encourage tumbling of the particles. A sinusoidal surface contour can be employed. A particularly preferred surface contour comprises sawtooth waves which are illustrated in schematic perspective partial cross-sectional view in FIG. 2. Each sawtooth wave has a leading face, 22, which is at a higher angle relative to a tangent to the liner than the trailing edge, 24. In a preferred embodiment the thermal processing apparatus rotates towards the leading face, represented by arrow R, thereby causing the particles to gather on the leading edge and tumble down the trailing edge as the thermal processing apparatus rotates thereby inhibiting caking of the powder. It is preferable that the liner is in segments, or tiles, which are interlocked such as with adjacent segments having interlocking tongue, 25, and groove, 26, which interlock the segments together radially. The liner is preferable constructed of SiC, SiN other chemically inert hard refractory material or combinations thereof.

The liner can be formed as a continuous unit or formed by attached appropriately shaped segments, or tiles, to an insulator, 28, which will be further described herein. By way of non-limiting example, the struts can be separated by about 1½ tube diameters. In an exemplary arrangement a 6 inch tube may have support struts every 9 inches.

With further reference to FIG. 1, the liner is encased in an insulator, 28, and preferably a low-density insulation. A very hard refractory tile such as the Blasch ceramics Ultron material is suitable as an insulator for demonstration of the invention. The insulator is between the liner, 20, and a preferably cylindrical shell, 30. The insulator can be preformed from low density insulating brick, of curved profile. Alternatively, the insulator can be cast in place, or formed of packed mineral wool.

The shell, 30, can be a single part, or several sections with expansion joints to accommodate thermal expansion and contraction. The shell is preferably formed of a mild steel.

The thermal processing apparatus preferably rotates by rolling on a multiplicity of rollers, 31, wherein at least one roller is a drive roller attached to a drive motor, 33, by way of a gear, chain, drive shaft or the like. Any roller which is not a drive roller is an idle roller which supports the weight, and allows the thermal processing apparatus to rotate on an axis. Since the heat is largely contained within the thermal processing apparatus the limitations associated with the design and materials used in the rolling mechanism is not particularly limiting. Roller races, 32, on an exterior surface of the shell are preferably provided for engagement with rollers thereby allowing the roller races to rotate on rollers during rotation of the thermal processing apparatus. It is preferably that the width of the rollers, measured parallel to the axis of rotation, is larger than the width of the roller race thereby allowing the roller race to move laterally on the roller in concert with thermal expansion and contraction.

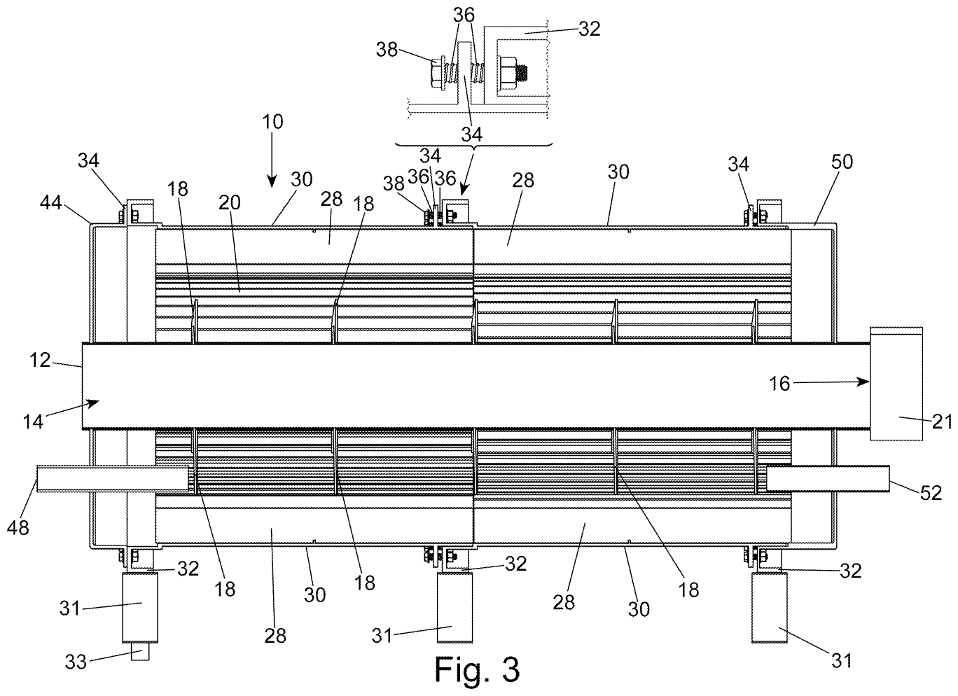

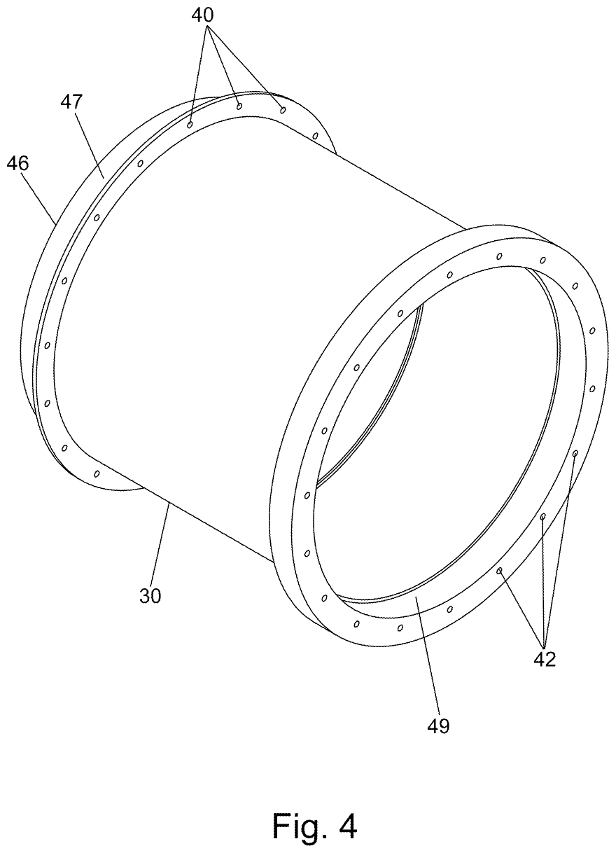

An embodiment will be described with reference to FIG. 3 wherein a thermal processing apparatus, 10, is illustrated in cross-sectional view. A shell, 30, is illustrated in isolated perspective view in FIG. 4 for clarity. Each roller race, 32, is illustrated as attached to a flange, 34. At least one spring, 36, on an attachment element, 38, allows for thermal expansion and contraction of adjacent shells wherein the attachment element extends through voids, 40, of the flange and engages with a mating void, 42, of the roller race. A threaded bolt is an exemplary attachment element as that allows the tension of the spring, or springs, to be easily adjusted. The roller race preferably has an inner diameter which is larger than the inner diameter of the shell thereby forming an offset, 49, wherein the difference is about the thickness of the shell. The flange is mounted a distance away from the edge, 46, thereby providing a lip, 47, wherein the lip extends into the offset thereby allowing adjacent shells to expand and contract with the lip sliding within the offset against the bias of the springs, 36.

With further reference to FIG. 3, an entrance cap, 44, on the entrance end with an entrance port, 48, allows for introduction of precursor powder to be sintered into the interior of the thermal processing apparatus. A exit cap, 50, on the exit end with an exit port, 52, allows the sintered powder to exit the interior of the thermal processing apparatus. The entrance cap or exit cap can be attached to the shell by mating with flanges or a roller race, in a similar manner to the mating the roller races and flange with the exception that the spring assemblies are not necessary.

Two adjacent shells are illustrated for the purposes of clarity. It would be apparent to those of skill in the art that the number of adjacent shells is flexible and many shells can be utilized to extend the thermal processing apparatus as long as desired with the caveat that rollers are preferred along the body to inhibit any sag or distortion during heating.

A particular feature of the thermal processing apparatus is that the exterior of the shell is at near ambient temperature. The low temperature of the exterior of the shell allows the thermal processing apparatus to roll on a multiplicity of rollers which are preferably roller bearing supported wheels. Mechanical loads are minimized by the design.

The entire assembly, from outer steel jacket to inside metal tube, all spins on its axis as one assembly.

The thermal processing apparatus is preferably not horizontal so that introduced precursor at one end advances uphill to the opposite end similar to the progress it would make if there was a helical groove on the surface of the liner. It is preferable that the thermal processing apparatus be up to 10° from horizontal as measured parallel to gravity. Two to seven degrees off of horizontal is exemplary for demonstrating the invention.

A controlled atmosphere can be introduced into the thermal processing apparatus more easily than convention systems since the atmosphere does not mix with the fuel gas combustion products.

The thermal processing apparatus can be used alone with a single thermal processing apparatus having powder passing therethrough. Alternatively, a multiplicity of thermal processing apparati can be used in series wherein one thermal processing apparatus feeds into a second thermal processing apparatus thereby allowing for the formation of temperature zones and residence time of the powder in a temperature zone. A series of thermal processing apparati can also be used in parallel to increase productivity. A series of thermal processing apparati can be used in combinations of serial and parallel to increase the effective throughput of lithium-ion cathode manufacture.

The precursor to a lithium-ion cathode material is not particularly limited herein and includes any compound comprising lithium, iron, nickel, manganese, cobalt or a dopant which, when heated forms a lithium ion cathode material selected from LiMO₂, LiMO₄ or LiMPO₄ as described elsewhere herein. Particularly preferred precursors comprise organic acids of lithium, iron, nickel, manganese, cobalt or a dopant with oxalates being particularly preferred.

The invention has been described with reference to preferred embodiments without limit thereto. One of skill in the art would realize additional embodiments which are described and set forth in the claims appended hereto.

Claimed is:

1. A thermal processing apparatus comprising:
at least one shell;
an insulator on an interior of said shell;
a liner on an interior of said insulator wherein said liner forms an inner cavity; and
a heater in said inner cavity.

2. The thermal processing apparatus of claim 1 wherein said shell is cylindrical.

3. The thermal processing apparatus of claim 1 wherein said shell comprises mild steel.

4. The thermal processing apparatus of claim 1 wherein said shell comprises at least one roller race on an exterior of said shell wherein said roller race rolls on a roller during rotation of said thermal processing apparatus.

5. The thermal processing apparatus of claim 1 wherein said heater is an electric element or a combustion tube.

6. The thermal processing apparatus of claim 5 further comprising a medium flowing through said combustion tube.

7. The thermal processing apparatus of claim 6 wherein said medium is a combustion mixture.

8. The thermal processing apparatus of claim 6 wherein said combustion tube comprises an entrance port for introduction of said medium into said combustion tube and an exit for allowing combustion gases to exit said combustion tube.

9. The thermal processing apparatus of claim 8 further comprising a heat exchanger in flow communication with said exit.

10. The thermal processing apparatus of claim 6 wherein said combustion tube comprises refractory metal.

11. The thermal processing apparatus of claim 1 wherein said combustion tube is suspended within said inner cavity.

12. The thermal processing apparatus of claim 11 wherein said combustion tube is suspended by struts.

13. The thermal processing apparatus of claim 1 wherein said combustion tube has a diameter which is at least 35% to no more than 65% of a diameter of said inner cavity.

14. The thermal processing apparatus of claim 13 wherein said combustion tube is at least 45% to no more than 55% of said diameter of said inner cavity.

15. The thermal processing apparatus of claim 1 wherein said liner comprises interlocked segments.

16. The thermal processing apparatus of claim 1 wherein said liner comprises a contour on an inner surface.

17. The thermal processing apparatus of claim 16 wherein said contour is sinusoidal.

18. The thermal processing apparatus of claim 16 wherein said contour is a saw-tooth contour.

19. The thermal processing apparatus of claim 16 wherein said contour comprises a leading face and a trailing edge.

20. The thermal processing apparatus of claim 19 wherein said leading face is at a higher angle relative to a tangent to said liner than said trailing edge.

21. The thermal processing apparatus of claim 1 comprising an axis of rotation wherein said axis of rotation is not horizontal.

22. The thermal processing apparatus of claim 21 wherein said axis of rotation is no more than 10° from horizontal.

23. The thermal processing apparatus of claim 22 wherein said axis of rotation is 2° to 7° from horizontal.

24. The thermal processing apparatus of claim 1 comprising multiple shells.

25. A method for forming a lithium-ion cathode material comprising:
providing a thermal processing apparatus comprising:
a shell;
an insulator on an interior of said shell;
a liner on an interior of said insulator wherein said liner forms an inner cavity; and
a heater in said inner cavity;
feeding a precursor to a lithium-ion cathode material in said inner cavity;
rotating said thermal processing apparatus; and
heating said precursor to form said lithium-ion cathode material; and
removing said lithium-ion cathode material from said thermal processing apparatus.

26. The method for forming a cathode material of claim 25 wherein said shell comprises mild steel.

27. The method for forming a cathode material of claim 25 wherein said shell comprises at least one roller race on an exterior of said shell wherein said roller race rolls on a roller during rotation of said thermal processing apparatus.

28. The method for forming a cathode material of claim 25 wherein said heater is an electric element or a combustion tube.

29. The method for forming a cathode material of claim 28 further comprising flowing a medium through said combustion tube.

30. The method for forming a cathode material of claim 29 wherein said medium is a combustion mixture.

31. The method for forming a cathode material of claim 28 wherein said combustion tube comprises an entrance port for introduction of said medium into said combustion tube and an exit for allowing combustion gases to exit said combustion tube.

32. The method for forming a cathode material of claim 31 further comprising a heat exchanger in flow communication with said exit.

33. The method for forming a cathode material of claim 28 wherein said combustion tube comprises refractory metal.

34. The method for forming a cathode material of claim 25 wherein said combustion tube is suspended within said inner cavity.

35. The method for forming a cathode material of claim 34 wherein said combustion tube is suspended by struts.

36. The method for forming a cathode material of claim 25 wherein said combustion tube has a diameter which is at least 35% to no more than 65% of a diameter of said inner cavity.

37. The method for forming a cathode material of claim 36 wherein said combustion tube is at least 45% to no more than 55% of said diameter of said inner cavity.

38. The method for forming a cathode material of claim 25 wherein said liner comprises interlocked segments.

39. The method for forming a cathode material of claim 25 wherein said liner comprises a contour on an inner surface.

40. The method for forming a cathode material of claim 39 wherein said contour is sinusoidal.

41. The method for forming a cathode material of claim 39 wherein said contour is a saw-tooth contour.

42. The method for forming a cathode material of claim 25 comprising an axis of rotation wherein said axis of rotation is not horizontal.

43. The method for forming a cathode material of claim 42 wherein said axis of rotation is no more than 10° from horizontal.

44. The method for forming a cathode material of claim 25 further comprising a second thermal processing apparatus wherein said feeding of said precursor is from said second thermal processing apparatus.
